(19) United States
(12) Patent Application Publication
(10) Pub. No.: US 2007/0016686 A1
(43) Pub. Date: Jan. 18, 2007

(54) Retrieval system and retrieval method for retrieving medical images

(76) Inventors: Robert J. Hollebeek, Berwyn, PA (US); Kevin Sterner, Lansdowne, PA (US)

Correspondence Address: RATNERPRESTIA, P O BOX 980, VALLEY FORGE, PA, 19482-0980, US

(21) Appl. No.: 11/180,137

(22) Filed: Jul. 13, 2005

(51) Int. Cl. G06F 15/173

(52) U.S. Cl. 709/238

(57) ABSTRACT

A retrieval system for retrieving medical images is provided. The retrieval system includes an archive for storing medical images, a routing device for determining selected medical images stored in the archive and for routing the selected medical images based on routing rules, and a plurality of end-user devices for use with the medical images for medical diagnosis, the selected medical images stored in the archive being automatically routed via the routing device from the archive to respective one or ones of the end-user devices.

### FIELD OF INVENTION

The present invention relates to the field of retrieval systems and more particularly to a method and system for retrieving medical images.

### BACKGROUND OF THE INVENTION

In recent years, many different types of medical images have increasingly been digitalized (e.g., x-ray images, full field mammography images and ultrasound images, among others) and these medical images are stored in a digital format. As such, hospitals are now experiencing a need for large storage systems to handle the large number of the medical images stored in the digital formats. As the number of stored medical images increases, storage capacity on medical networks (e.g., secured hospital networks) is becoming more prohibitive, since space to store such images also must increase.

What is needed is an external archive for medical images which can store and retrieve the medical images saved on the external archive in real-time or near real time. That is, medical images may be saved digitally in the external archive and pre-delivered to an end-user device for diagnosis of the archived medical image by an end-user in sufficient time to reduce or substantially eliminate wait time of the end-user.

### SUMMARY OF THE INVENTION

The invention may be embodied as a retrieval system, a method or a computer readable carrier for retrieving medical images. A retrieval system may include an archive for storing medical images, a routing device for determining selected medical images stored in the archive and for routing the selected medical images based on routing rules, and a plurality of end-user devices for use with the medical images for medical diagnosis, the selected medical images stored in the archive being automatically routed via the routing device from the archive to respective end-user devices.

The invention may be further embodied as a retrieval system and may include a plurality of end-user devices for medical diagnosis, a routing table that identifies routing information of the plurality of end-user devices, a worklist that includes selection information for selecting medical images to be routed to at least one of the end-user devices, and a routing device for transfer of the selected medical images stored in the archive, in advance of a use thereof to a respective one or ones of the end-user devices based on the information in the routing table and the worklist.

The invention may be further embodied as a retrieval system and may include a routing table for identifying routing address information of a plurality of end-user devices, routing rule storing unit for storing a plurality of routing rules, a determination unit for determining a respective one or ones of the end-user devices for routing of selected medical images in accordance with routing rules stored in the routing rule storing unit, a routing address establishing unit for establishing the routing address or routing addresses of the determined end-user devices to be used in routing the selected medical images, and a pre-delivery unit for delivery of the selected medical images, in accordance with the established routing address or routing addresses and in advance of a use thereof, from the archive to the respective one or ones of the end-user devices at the respective one or ones of the end-user devices to reduce or substantially eliminate wait time for display of the selected medical images.

### BRIEF DESCRIPTION OF THE DRAWINGS

The invention is best understood from the following detailed description when read in connection with the accompanying drawings. It is emphasized that according to common practice the various features/elements of the drawings may not be drawn to scale. On the contrary, the dimensions of various features/elements may be arbitrarily expanded or reduced for clarity. Moreover, in the drawings, common numerical references are used to represent like features/elements. Included in the drawings are the following figures:

FIG. 1 is a schematic diagram illustrating a storage and retrieval system in accordance with an exemplary embodiment of the present invention;

FIG. 2 is a schematic diagram illustrating a storage and retrieval system in accordance with another exemplary embodiment of the present invention;

FIG. 3 is a schematic diagram illustrating a storage and retrieval system in accordance with another exemplary embodiment of the present invention; and

FIG. 4 is a flow chart of a retrieval method in accordance with another exemplary embodiment of the present invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims without departing from the invention.

Although the present invention is described in terms of a storage and retrieval system for retrieving medical images, the present invention may be applied to other systems, for example routing systems which route information that is external to a secured network to network resources on the secured network, for example, a hospital network, or an office network, among others. It is contemplated that embodiments of the present invention may be applicable generally to retrieval of information and routing of that information to end-user devices.

Although the present invention is described in terms of an external archive for storing medical images, a routing device or network interface device and a plurality of end-user devices, it is contemplated that embodiments of the present invention are not limited to a single routing device or a single network interface device, but instead selected images may be routed via any number of such devices to an end-user device or end-user devices.

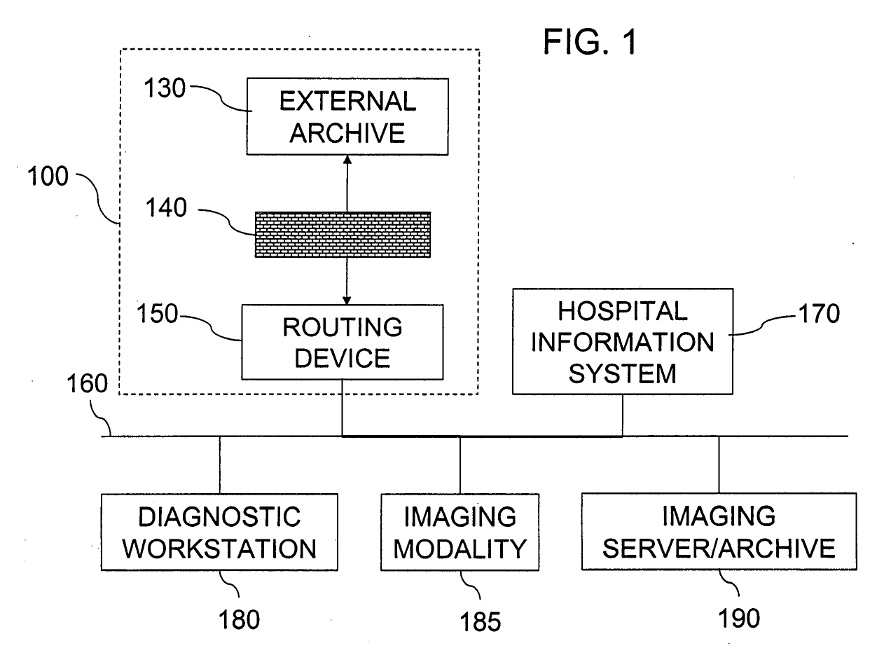

FIG. 1 is a schematic diagram illustrating a storage and retrieval system 100 in accordance with an exemplary embodiment of the present invention.

Referring now to FIG. 1, storage and retrieval system 100 is configured to work with a secured network 160 (e.g., a secured medical network) and includes an external archive 130, a firewall 140 and a routing device 150. Firewall 140 prevents unauthorized users from accessing secured network elements 170, 180, 185 and 190 and routing device 150 which are coupled to secured network 160. External archive 130 may include storage for storing medical images in digital format, for example, x-ray images, mammography images, other radiological images, ultrasound images, and/or patient histories stored as images, among others. External archive 130 may communicate via firewall 140 and routing device 150 to secured network 160.

Secured network 160 may include any number of network resources, for example: (1) a hospital information system 170 which manages hospital information records such as patients appointments, medical procedure schedules and medical resource availability, among others; (2) one or more diagnostic workstations 180 that are used by medical personnel (e.g., end-users) for review and diagnosis of patient studies and/or selected medical images, for example, x-ray studies/x-ray images, mammography studies/mammography images, ultrasound studies/ultrasound images, and/or other radiological studies/other radiological images, among others; (3) one or more imaging modalities 185 for generating the patient studies/selected medical images reviewed at the one or more diagnostic workstations 180; and (4) one or more imaging servers/archives 190 for storing patient studies/selected medical images either temporarily or permanently based on storage rules.

Diagnostic workstations 180 refer to computer workstations used by a medical personnel (e.g., radiologists, medical technicians, and others) to perform diagnosis by referencing selected images (including archived images). These diagnostic workstations are typically capable of image processing to enhance images and to compare sets of images (patient studies) for medical diagnosis of a patient's condition.

Imaging modalities 185 refer to systems for imaging of a patent, for example computed tomography (CT) scan, Magnetic Resonance Imaging (MRI), Positron Emission Topography (PET) scan, Ultrasound Imaging, and X-ray Imaging, among others. Digital images may be produced directly from the imaging process or, otherwise, a film of an image may be scanned into a digital format and stored in a file.

Hospital information system 170 refers to any system used on a hospital/medical network that provides information for use in determining selection of medical images/patent studies to be retrieved from the external archive and/or that provides information for use in determining routing or scheduling of the selected medical images/patent studies to particular end-user devices.

Secured network 160 may operate using one or more network protocols/standards, for example, in secured medical networks standards such as Digital Imaging in Communications in Medicine (DICOM) and/or Hospital Level 7 (HL7). Routing device 150 may provide protocol conversion from the protocols/standards used on secured network 160 to a protocol for communication to external archive 130.

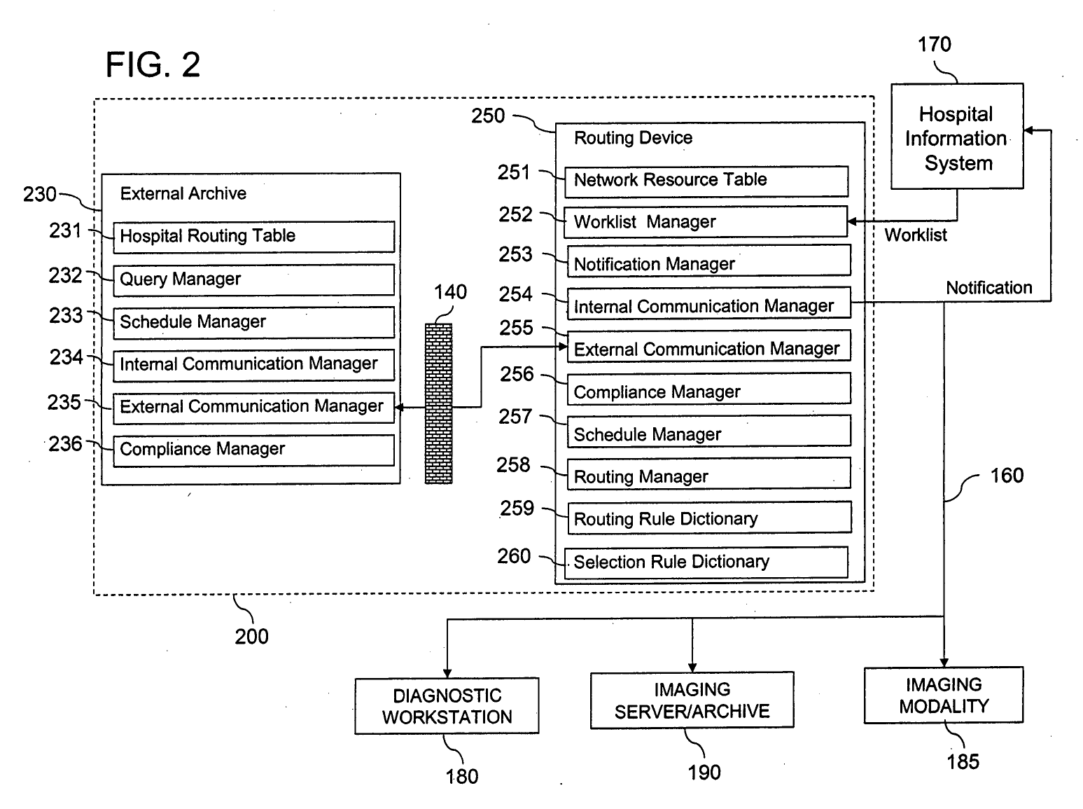

FIG. 2 is a schematic diagram illustrating a storage and retrieval system for retrieving medical images in accordance with another exemplary embodiment of the present invention.

Now referring to FIG. 2, storage and retrieval system 200 may include an external archive 230, firewall 140 and a routing device 250 and may be configured to work with secured network 160. Secured network 160 may include: (1) hospital information system 170; (2) end-user devices such as one or more diagnostic workstations 180 and/or one or more imaging modalities 185; and (4) one or more image servers/archives 190.

In one exemplary embodiment, routing device 250 may include: (1) a network resources table 251; (2) a worklist manager 252; (3) a notification manager 253; (4) an internal communication manager 254; (5) an external communication manager 255; (6) a compliance manager 256; (7) a schedule manager 257; (8) a routing manager 258; (9) a routing rule dictionary 259; and (10) a selection rule dictionary 260. Network resource table 251 may include a table which defines network addresses for each end-user device 180 and 185 having medical images routed thereto or therefrom.

Worklist manager 252 of routing device 250 may receive a worklist from hospital information system 170. Worklist manager 252 may also determine a selection criteria for selecting medical images from external archive 230 according to selection rules stored in selection rule dictionary 260.

Notification manager 253 may provide a notification to hospital information system 170 as to whether a particular medical image and/or patient study which is selected for retrieval by worklist manager 252 has been returned to routing device 250 from external archive 230 for use by, for example, a respective diagnostic workstation 180. The notification may be a status report of selected images/patent studies returned to routing device 250 and/or may be an exception report which indicates errors/compliance issues which prevented certain selected images/patience studies from being returned to routing device 250.

Internal communication manager 254 may manage communication from routing device 250 to respective network resources (for example, resources 180, 185 and 190) and hospital information system 170 based on protocols/standards of secured network 160. External communication manager 255 may manage communication between routing device 250 and external communication manager 235 of external archive 230. External communication managers 235 and 255 are desirably configurable to allow communication via firewall 140. That is, external communication managers 235 and 255 may allow reconfiguration of protocols and ports to enable communication through firewall 140 between routing device 250 and external archive 230.

Compliance manager 256 may determine whether medical images and/or patient studies selected by worklist manager 252 based on information from hospital information system 170 via the worklist are in compliance with, for example, Health Insurance Portability & Accountability Act (HIPAA) compliance requirements or other archive policies or procedures. If the information in the worklist from the hospital is not in compliance with HIPAA compliance requirements or the other archive policies or procedures, compliance manager 256 directs notification manager 253 to notify hospital information system 170 in a notification or status report (e.g., an exception report) that specific requirements for retrieval of selected medical images are not in compliance with particular HIPAA compliance requirements and/or the other archive policies or procedures.

Schedule manager 257 may manage scheduling of internal and external communications from/to routing device 250 by internal communication manager 254 and external communication manager 255 based on timing requirements. Such timing requirements may be determined according to worklist content such as a patient appointment time, a physician schedule, a modality involved, an examination procedure involved, a priority set for retrieving the selected images based, for example, on user-selectable urgency criteria, and/or other established scheduling rules.

Routing manager 258 may manage routing of selected medical images to network resources (e.g., diagnostic workstations 180, imaging servers/archives 190 and imaging modalities 185) based on routing rules stored in routing rule dictionary 259. Routing rule dictionary 259 may include reconfigurable routing rules.

For example, routing rule dictionary 259 may include: (1) an out-of-service list which indicates network resources that are not available or are not available at specifically identified times; (2) routing rules based on workday status, e.g., weekday, weekend and/or holiday status; (3) routing rules individually tailored to each department of a hospital/and/or on a physician-by-physician basis. For example, based on scheduling set forth by schedule manager 257, routing manager 258 may determine that specific network resources are unavailable based on the out-of-service list in routing rule dictionary 259, and may redirect selected medical images to other network resources. As another example, routing rule dictionary may direct routing of all selected mammography images/patent studies to a plurality of network resources (e.g., diagnostic work stations 180), simultaneously, so that any of the diagnostic workstations 180 may have the selected images for review by any department radiologist.

Routing manager 258 may determine routing of selected medical images to network resources according to addresses of the network resources in network resource table 251, and the worklist received from hospital information system 170 via worklist manager 252. The worklist may identify certain information such as the modality involved, a patient identifier, a department identifier, a physician identifier, and a location of the patient appointment, among others that may be used in conjunction with various routing rules to route the selected medical images to, for example, end-user devices 180 and 185.

External archive 230 may include: (1) a hospital routing table 231; (2) a query manager 232; (3) a schedule manager 233; (4) an internal communication manager 234; (5) an external communication manager 235; and (6) a compliance manager 236. External archive 230 may desirably include hospital routing table 231 to route selected medical images and/or patient studies to a particular medical network 160 via routing device 250 or, otherwise, external archive 230 may receive, via external communication manager 235 an address, for example an IP address, from routing device 250 to return the selected medical images and/or patient studies.

Query manager 232 may manage generation of queries based on information (e.g., selection criteria) provided by worklist manager 252 of routing device 250. That is, a query may be generated based on selection criteria from worklist manager 252 which is communicated to external archive 230 via external communication managers 235 and 255. For example, routing device 250 may provide image selection criteria to archive 230 and may request medical images matching the image selection criteria to be returned to routing device 250 so that routing device 250 may route the returned images to respective one or ones of the end-user devices 180 and/or 185.

Schedule manager 233 of external archive 230 is similar to that of schedule manager 257 and controls timing of internal communication manager 234 and external communication manager 235 of external archive 230. Internal and external communication managers 234 and 235 of external archive 230 are similar to those of internal communication manager 254 and 255, respectively, and control internal communication inside external archive 230 via a first protocol/standard of external archive 230 and external communication between external communication managers 235 and 255 via an second protocol/standard, different from the internal protocol inside secured network 160.

Compliance manager 236 assures compliance with both archive policies and procedures and HIPAA requirements for external archive 230. For example, retrieval requests from an unauthorized secured network 160 (i.e., one that is not authorized to operate with external archive 230 stopped without further processing, or retrieval requests from an authorized secured network 160 may be stopped without further processing, if the particular hospital is not approved for retrieval of the selected images. That is, compliance manager 236 may determine whether a valid request is being processed from an authorized secured network 160 based on information in the worklist and selection criteria from worklist manager 252 of routing device 250.

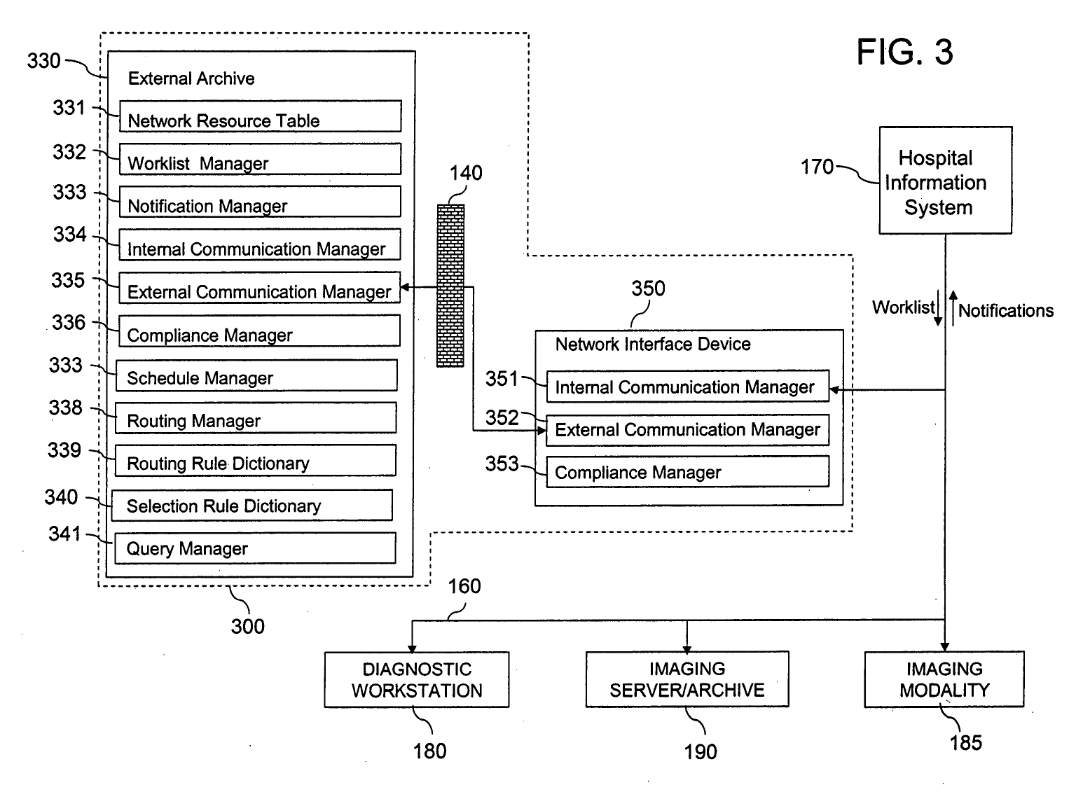

FIG. 3 is a schematic diagram illustrating a storage and retrieval system for retrieving medical images in accordance with another exemplary embodiment of the present invention.

Now referring to FIG. 3, storage and retrieval system 300 may include an external archive 330, a firewall 140 and a network interface device 350, and may be configured to work with secured network 160. In one exemplary embodiment, network interface device 350 may include: (1) an internal communication manager 351; (2) an external communication manager 352; and (3) a compliance manager 353.

Internal communication manager 351 may manage communication from network interface device 350 to respective network resources (for example, resources 180, 185 and 190) on secured network 160 based on protocols of the secured network 160. External communication manager 352 may manage communication between network interface device 350 and external communication manager 335 of external archive 330. External communication managers 335 and 352 are desirably configurable to allow communication via firewall 140.

Compliance manager 353 is only briefly described, since it is similar in function to that of compliance manager 256 described in FIG. 2. If the worklist information from hospital information system 170 is not in compliance with HIPAA compliance requirements or the other archive policies or procedures, compliance manager 353 may direct internal communication manager 351 to notify hospital information system 170 that specific requirements identified by compliance manager 353 are not in compliance with HIPAA compliance requirements or the other archive policies or procedures.

External archive 330 may include: (1) a network resources table 331; (2) a worklist manager 332; (3) a notification manager 333; (4) an internal communication manager 334; (5) an external communication manager 335; (6) a compliance manager 336; (7) a schedule manager 337; (8) a routing manager 338; (9) a routing rule dictionary 339; and (10) a selection rule dictionary 340; and (11) a query manager 341.

Network resource table 331 may include a table which defines network addresses for each end-user device, for example, diagnostic workstations 180 and imaging modalities 185 having medical images routed thereto or therefrom. That is, the table for each secured network 160 includes records having at least intra-network and inter-network addresses (e.g., IP addresses identifying network interface device 350 and end-user devices 180 and 185.) and end-user device identifiers for each end-user device in the respective secured network 160.

Network resource table 331 may be updated by passing records from a respective secured network 160 (e.g., a medical network) to archive 330. The records may include the inter-network addresses and end-user device identifiers to be added to the table for the respective secured medical network, when a new end-user device is being added to respective secured medical network 160, and the inter-network addresses and end-user device identifiers to be deleted from the table when end-user device 180 and 185 is being removed from the respective secured medical network 160.

Worklist manager 332 of external archive 330 may receive a worklist from hospital information system 170 via network interface device 350 and may determine a selection criteria for selecting medical images from external archive 330 according to selection rules stored in selection rule dictionary 340. The selection rules in selection rule dictionary 340 may be generalized and apply to each secured network 160 which is connected to external archive 330 or, otherwise, may be different for each secured network 160 such that each secured network may have a different set of selection rules stored in selection rule dictionary 340.

Notification manager 333 may provide notification to hospital information system 170 as to whether a particular medical image or patient study which is selected for retrieval by worklist manager 332 and query manager 341 is retrievable to secure network 160. That is, for example, whether the request is in compliance with HIPAA and other archive policies and procedures. Such notifications are routed to hospital information system 170 via network interface device 350.

Internal communication manager 334 may manage communication inside external archive 330, for example, to request retrieval of selected images from storage (not shown). External communication manager 335 may manage communication between external archive 330 and external communication manager 352 of network interface device 350. External communication managers 335 and 352 are desirably configurable to allow communication via firewall 140.

Compliance manager 336 of external archive 330 may determine whether medical images and/or patient studies requested by the hospital via the worklist are in compliance with, for example, Health Insurance Portability & Accountability Act (HIPAA) compliance requirements or other archive policies or procedures. If the requested medical images from hospital information system 170 are not in compliance with HIPAA compliance requirements or the other archive policies or procedures, compliance manager 336 may direct notification manager 333 to notify hospital information system 170 that specific requirements identified by compliance manager 336 are not in compliance and further processing may be discontinued.

Schedule manager 337 may manage scheduling of internal and external communications from external archive 330 by internal communication manager 334 and external communication manager 335 based on timing requirements. Such timing requirements may be determined according to worklist content. Routing manager 338 may manage routing of selected medical images to network resources (e.g., diagnostic workstations 180, imaging servers/archives 190 and imaging modalities 185) based on routing rules in routing rule dictionary 339.

Routing rule dictionary 339 is similar to routing rule dictionary 259 of FIG. 2. However, routing rule dictionary 339 may store routing rules for a plurality of secured networks 160 and may include reconfigurable routing rules which may be generalized for each secured network or, individualize to allow specific routing for each secured network. Routing manager 338 may determine routing of selected medical images to network resources of a particular secured network according to addresses of the network resources in network resource table 331 and information in the worklist received from hospital information system 170 via network interface device 350.

Selection rule dictionary 340 is similar to selection rule dictionary 260 of FIG. 2. However, selection rule dictionary 340 may store selection rules for a plurality of secured networks 160 and may include reconfigurable selection rules which may be generalized for each secured network or, individualize to allow specific selection rules for each secured network. Query manager 341 may generate a query to select medical images according to these selection rules and information in the worklist received from hospital information system 170 via network interface device 350.

Internal and external communication managers 334 and 335 of external archive 330 are similar to those of internal communication manager 352 and 353, respectively, and control internal communication inside the external archive 330 via an internal protocol of external archive 330 and external communication between the external communication managers 335 and 352 via a second protocol, different from the internal protocol inside secured network 160.

Although only one secured network 160 with one routing device 250 or one network interface device 350 is illustrated, it is contemplated that any number of secured networks are possible and each of these secured networks may have any number of routing devices 250 or network interface devices 350 to route/interface between a respective secured network and external archive 130 or 330.

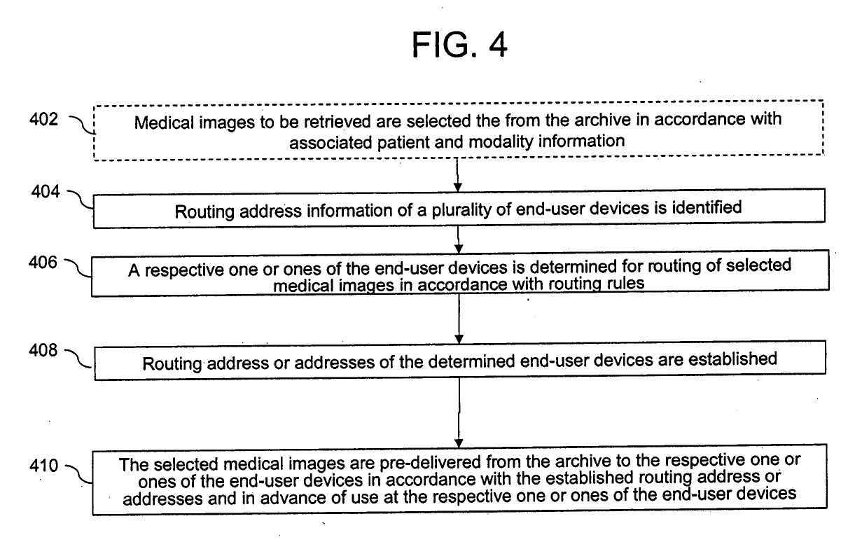

FIG. 4 is a flow chart of a retrieval method in accordance with another exemplary embodiment of the present invention.

Now referring to FIG. 4, at block 402, medical images to be retrieved may optionally be selected from archive 130, 230 or 330 in accordance with selection rules, for example, associated patient and modality information, among others. For example, selection of medical images may be determined by matching a patient identifier and modality information associated with each respective medical image in external archive 130, 230 or 330 to patient identifier and modality information associated with a scheduled medical procedure.

Although, selection based on patient identifier and modality information is illustrated, the selection of medical images may be determined based on any number of other criteria stored as selection rules in selection rule dictionary 260 or 340. That is, a determination of which medical images to be retrieved (i.e., selected) may be made based on, for example, a previous diagnosis, the modality involved, and particular preferences of the treating physician as to image selection, among many others. As an example, if a mammography is the modality involved, the selection rule may be all previous mammography images for the particular patient, may be only past mammography images for the particular patient covering a pre-determined period (e.g., the last 5 years), or may be all previous mammography images for the particular patient and all chest MRIs if the previous diagnosis was breast cancer.

Moreover, the selection request via the worklist from the hospital information system 170 may include a selection detail indicator which may indicate the level-of-detail of the images to be selected. That is, as the selection detail indicator indicates an increased level-of detail to be selected, correspondingly more potentially relevant images may be selected from external archive 130, 230 or 330. This selection detail indicator enables a particular selection request to include more or less images to be retrieved. For example, a worklist may include a selection detail indicator indicating a level-of-detail of the images to be selected, and the medical images to be retrieved may be selected by generating a query request to retrieve the selected medical images from external archive 130, 230 or 330 according to the selection detail indicator in the worklist.

At block 404, routing address information of a plurality of end-user devices may be identified in the routing table of resource network table 251 or 331 for use at block 408 in routing the selected medical images to respective end-user devices identified.

At block 406, the respective one or ones of the end-user devices may be determined for routing of selected medical images. These end-user devices may be determined in accordance with routing rules stored in routing rule dictionary 259 or 339. The routing rules refers to rules for routing of medical images and may be based on criteria such as the particular physician involved, the modality involved, a previous diagnosis for the patent, a patient appointment time, a patient appointment location, second medical opinion rules, and/or medical resource availability (e.g., workstation availability and medical personnel availability), among others.

At block 408, a routing address or routing addresses of the determined end-user devices may be established. At block 410, the selected medical images may be pre-delivered from the archive to the respective one or ones of the end-user devices in accordance with the established routing address or addresses. Pre-delivery of the selected medical images refers to delivery to the respective end-user device or devices in advance of their use by (e.g., in sufficient time to have the selected images available for use by), for example, medical personnel. This pre-delivery reduces or substantially eliminates wait time for display of the selected medical images.

According to certain embodiments of the present invention, system 100 or 200 may include archive 130 or 230 for storing medical images, routing device 150 or 250 for determining selected medical images stored in archive 130 or 230 and for routing the selected medical images based on routing rules, and a plurality of end-user devices, for example 180 and 185, for use with the medical images for medical diagnosis, the selected medical images stored in archive 130 or 230 being automatically routed via routing device 150 or 250 from archive 130 or 230 to respective end-user devices 180 and 185.

According to certain embodiments of the present invention, routing device 150 or 350 may route the selected medical images from archive 130 or 330 directly to a respective one or ones of end-user devices, for example 180 or 185.

According to embodiments of the present invention, routing device 150, 250 or 350 may have a controller (not shown), which controls access to a particular secured medical network 160. The plurality of end-user devices 180 and 185 may be disposed on secured medical network 160 and accessible though routing device 150, 250 or 350. Storage and retrieval system 100, 200 or 300 may include further routing devices, each including a controller which controls access to corresponding medical networks, and further pluralities of end-user devices disposed on the corresponding medical networks and accessible though the further routing devices such that the archive is external to each of the medical networks and routes the selected medical images among the medical networks according to predefined routing rules.

According to embodiments of the present invention, routing devices 150, 250 or 350 at respective medical networks may translate the routing protocols internal to the respective medical network to a common routing protocol used externally between each routing device and archive 130, 230 or 330.

According to certain embodiments, worklist manager 252 or 332 in conjunction with selection rule dictionary 260 and 340, respectively, provides for selection of the medical images/patient studies to be retrieved from archive 230 or 330 in accordance with associated patient identifier and modality information of respective medical images. The patient identifier and modality information associated with each respective medical image in archive 230 and 330 may be matched to patient identifier and modality information associated with, for example, a scheduled medical procedure.

Although the invention has been described in terms of a storage and retrieval system, it is contemplated that the invention may be implemented in software on microprocessors/general purpose computers (not shown). In this embodiment, one or more of the functions of the various components may be implemented in software that controls the general purpose computer. This software may be embodied in a computer readable carrier, for example, a magnetic or optical disk, a memory-card or an audio frequency, radio-frequency, or optical carrier wave.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A retrieval system for retrieving medical images, comprising:
an archive for storing medical images;
a routing device for determining selected medical images stored in the archive and for routing the selected medical images based on routing rules; and
a plurality of end-user devices for use with the medical images for medical diagnosis, the selected medical images stored in the archive being automatically routed via the routing device from the archive to respective one or ones of the end-user devices.

2. The system of claim 1, wherein the routing device routes the selected medical images from the archive directly to the respective one or ones of the end-user devices.

3. The system of claim 1, wherein the routing device includes a controller which controls access to a medical network, and the plurality of end-user devices is disposed on the medical network and accessible though the routing device, the system further comprising:
further routing devices, each including a controller which controls access to corresponding medical networks; and
further pluralities of end-user devices disposed on the corresponding medical networks and accessible though the further routing devices such that the archive is external to each of the medical networks and routes the selected medical images among the medical networks according to predefined routing rules.

4. The system of claim 3, wherein the routing devices at respective medical networks translate the routing protocols internal to the respective medical network to a common routing protocol used externally between each routing device and the archive.

5. The system of claim 3, wherein the archive includes a routing table with at least hospital routing information to route selected medical images from the external archive to a respective medical network.

6. The system of claim 5, wherein the routing table for each medical network comprises records including at least intra-network and inter-network addresses and end-user device identifiers for each end-user device.

7. The system of claim 6, wherein the routing table is updated by passing records from a respective medical network to the archive, the records including the inter-network addresses and end-user device identifiers to be added to the routing table for the respective medical network, when a new end-user device is being added to the respective medical network, and the inter-network addresses and end-user device identifiers to be deleted from the routing table when an existing end-user device is being removed from the respective medical network.

8. The system of claim 1, wherein the routing device provides image selection criteria to the archive and requests medical images matching the image selection criteria to be returned to the routing device, the routing device routing the returned images to the respective one or ones of the end-user devices.

9. A retrieval system for retrieving medical images, comprising:
a plurality of end-user devices for medical diagnosis;
a routing table that identifies routing information of the plurality of end-user devices;
a worklist that includes selection information for selecting medical images to be routed to at least one of the end-user devices; and
a routing device for transfer of the selected medical images stored in the archive in advance of a use thereof to respective one or ones of the end-user devices based on the information in the routing table and worklist.

10. A retrieval system for retrieving medical images, comprising:
a routing table for identifying routing address information of a plurality of end-user devices;
a routing rule storing unit for storing a plurality of routing rules;
a determination unit for determining a respective one or ones of the end-user devices for routing of selected medical images in accordance with routing rules stored in the routing rule storing unit;
a routing address establishing unit for establishing the routing address or addresses of the determined end-user devices to be used in routing the selected medical images; and
a pre-delivery unit for delivery of the selected medical images, in accordance with the established routing address or addresses and in advance of a use thereof, from the archive to the respective one or ones of the end-user devices at the respective one or ones of the end-user devices.

11. The system of claim 10, further comprising:
a selection unit for selecting the medical images to be retrieved from the archive in accordance with associated patient identifier and modality information of respective medical images, the patient identifier and modality information associated with each respective medical image in the archive being matched to patient identifier and modality information associated with a scheduled medical procedure.

12. The system of claim 10, wherein the routing of the selected medical images is from the archive directly to the respective one or ones of the end-user devices.

13. The system of claim 10, wherein the determining unit determines the respective one or ones of the end-user devices in accordance with at least one of a patient appointment time, a patient appointment location, a patient confirmation or a medical resource availability.

14. The system of claim 13, wherein the medical resource availability includes an availability of respective end-user devices and/or an availability of medical personnel.

15. The system of claim 14, wherein the pre-delivery unit is configured for advance delivery of the selected medical images in sufficient time to have the selected images available at the respective one or ones of the end-user devices to reduce or substantially eliminate wait-time for display of the selected medical images.

16. A method of retrieval of medical images from an archive to one or more end-user devices, the method comprising the steps of:
a) identifying routing address information of a plurality of end-user devices;
b) determining a respective one or ones of the end-user devices for routing of selected medical images in accordance with routing rules;
c) establishing the routing address or addresses of the determined end-user devices; and
d) pre-delivering the selected medical image or images from the archive to the respective one or ones of the end-user devices in accordance with the established routing address or addresses and in advance of use at the respective one or ones of the end-user devices.

17. The method of claim 16, further comprising the step of:
e) selecting the medical images to be retrieved from the archive in accordance with associated patient and modality information of respective medical images.

18. The method of claim 17, wherein a respective worklist includes a selection detail indicator indicating a level-of-detail of the images to be selected, and step (e) of selecting the medical images to be retrieved includes the step of determining a query request to retrieve specified medical images according to the selection detail indicator in the respective worklist.

19. The method of claim 17, wherein step (e) of selecting the medical images includes:
matching patient identifier and modality information associated with each respective medical image in the archive to patient identifier and modality information associated with a scheduled medical procedure.

20. The method of claim 16, wherein step (b) of determining the respective one or ones of the end-user devices in accordance with routing rules includes the step of:
determining the respective one or ones of the end-user devices in accordance with at least one of a patient appointment time, a patient appointment location, or medical resource availability.

21. The method of claim 20, wherein the medical resource availability includes an availability of an end-user device or devices and/or an availability of medical personnel.

22. The method of claim 16, wherein step (d) of pre-delivering the selected medical image or images in advance includes:
advance delivery of the selected medical images in sufficient time to have the selected images available at the respective one or ones of the end-user devices to reduce or substantially eliminate wait time for display of the selected medical images.

23. A computer readable carrier including software that is configured to control a general purpose computer to implement a method embodied in a computer readable medium to control retrieval of selected medical images, the method comprising the steps of:
a) identifying routing address information of a plurality of end-user devices;
b) determining a respective one or ones of the end-user devices for routing of selected medical images in accordance with routing rules;
c) establishing the routing address or addresses of the determined end-user devices; and
d) pre-delivering the selected medical image or images from the archive to the respective one or ones of the end-user devices in accordance with the established routing address or addresses and in advance of use at the respective one or ones of the end-user devices.
